(19) United States
(12) Patent Application Publication
(10) Pub. No.: US 2013/0242577 A1
(43) Pub. Date: Sep. 19, 2013

(54) FASTENER OF LED LIGHTING DEVICE

(71) Applicant: JIA-SHING WONG, KOTAKINABALU SABAH (MY)

(72) Inventor: JIA-SHING WONG, KOTAKINABALU SABAH (MY)

(21) Appl. No.: 13/787,839

(22) Filed: Mar. 7, 2013

(30) Foreign Application Priority Data
Mar. 14, 2012 (TW) 101204574

(51) Int. Cl. F21V 21/08

(52) U.S. Cl. CPC F21V 21/08
USPC 362/382

(57) ABSTRACT

A fastener is provided for an LED lighting device. The LED lighting device includes a light emission section and a heat dissipation section. The lighting device has opposite ends each provided with the fastener. The fastener has a base that includes a retention section and first and support sections extending upward therefrom. The first and second support sections are arranged at opposite sides of the retention section. The first and second support sections each have a top end forming a flat top surface. The retention section includes a pawl. Two fasteners are coupled to the opposite ends of the LED lighting device so that the LED lighting device can be independently mounted to positioning rails. When the LED lighting device gets broken, it only needs to remove the LED lighting device alone for replacement. In this way, the operation of replacement and maintenance of the LED lighting device is simplified.

### (a) TECHNICAL FIELD OF THE INVENTION

The present invention generally relates to a structure of a fastener of an LED (Light-Emitting Diode) lighting device, and more particularly to a fastener of an LED lighting device that allows installation and replacement of the LED lighting device to be done easily.

### (b) DESCRIPTION OF THE PRIOR ART

LED has various advantages, including low power consumption, saving energy, long lifespan, small volume, and fast response, and is gradually replacing the conventional light bulb and widely used in various lighting fixtures. The development of LED lighting devices has been of a significant progress and the conditions for the LED lighting device to be applied various field of illumination are getting mature.

As shown in FIG. 1, a conventional LED lighting device 1 comprises a plurality of light source modules 11 that is composed of a plurality of light-emitting diodes and a frame 12.

The light source modules 11 are mounted to the frame 12 by threaded fasteners 13 in order to form the LED lighting device 1. The frame has two opposite sides from each of which a raised rib 121 extends. The LED lighting device 1 is mounted to slide rails (not shown) that are provided for supporting the LED lighting device 1 by means of the ribs 121 of the frame 12. In this way, the LED lighting device 1 can be embedded in a ceiling or a wall to allow the LED lighting device 1 projects light for illumination.

The conventional way of positioning the LED lighting device 1 by means of the ribs 121 of the frame 12 extending from the LED lighting device 1 is effective in securing the LED lighting device 1 in position. However, as discussed above, the light source modules 11 of the LED lighting device 1 are individually fixed to the frame 12 by threaded fasteners. When one of the light source modules 11 gets broken, repairing the LED lighting device 1 must be done by first removing the entire LED lighting device 1 and then the broken light source module 11 can be replaced. Afterwards, the entire LED lighting device 1 must be re-installed again. The conventional structure that achieves positioning of the LED lighting device 1 through the ribs 121 on the opposite sides of the frame 12 definitely makes replacement and maintenance of the LED lighting device 1 very inconvenient and difficult. It is thus a challenge of the LED lighting industry to provide a structure of LED lighting device that greatly simplifies the operation of replacement and maintenance.

### SUMMARY OF THE INVENTION

In view of the above discussed problems and shortcoming of the conventional LED lighting device of being difficult to carry out an operation of replacement and maintenance, the present invention aims to overcome such problems and shortcomings by providing a fastener of LED lighting device.

Thus, the primary object of the present invention is to provide a fastener of LED lighting device. The LED lighting device comprises a light emission section and a heat dissipation section. The lighting device has opposite ends each provided with the fastener. The fastener comprises a base. The base comprises a retention section and a first support section and a second support section extending upward therefrom. The first support section and the second support section are arranged at opposite sides of the retention section. The first support section and the second support section each have a top end forming a flat top surface. The retention section comprises a pawl. Two fasteners are coupled to the opposite ends of the LED lighting device so that the LED lighting device can be independently mounted to positioning rails. When the LED lighting device gets broken, it only needs to remove the specific one LED lighting device alone from the fasteners for replacement. There is no need to remove the completely set of lighting fixture as is generally done in the prior art. In this way, the operation of replacement and maintenance of the LED lighting device is simplified.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a conventional LED lighting device.

FIG. 1A is an enlarged view of a circled portion of FIG. 1.

FIG. 2 is an exploded view showing an LED lighting device according to the present invention.

FIG. 3 is a perspective view showing the LED lighting device of the present invention in an assembled form.

FIG. 4 is a perspective view showing an application of the LED lighting device of the present invention.

FIG. 5 is a cross-sectional view of FIG. 4.

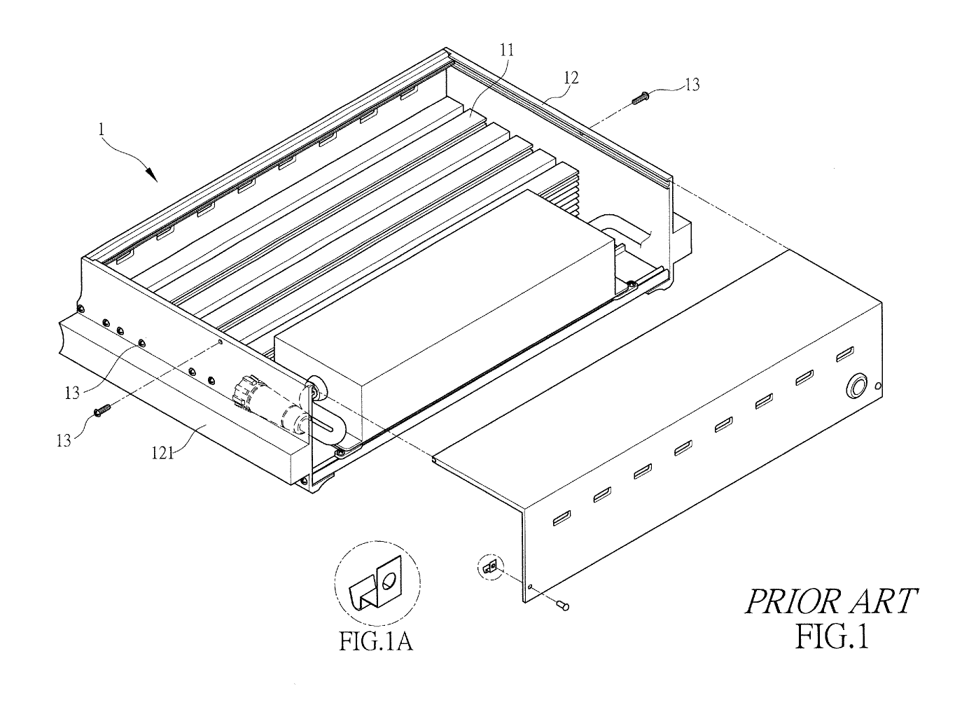

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

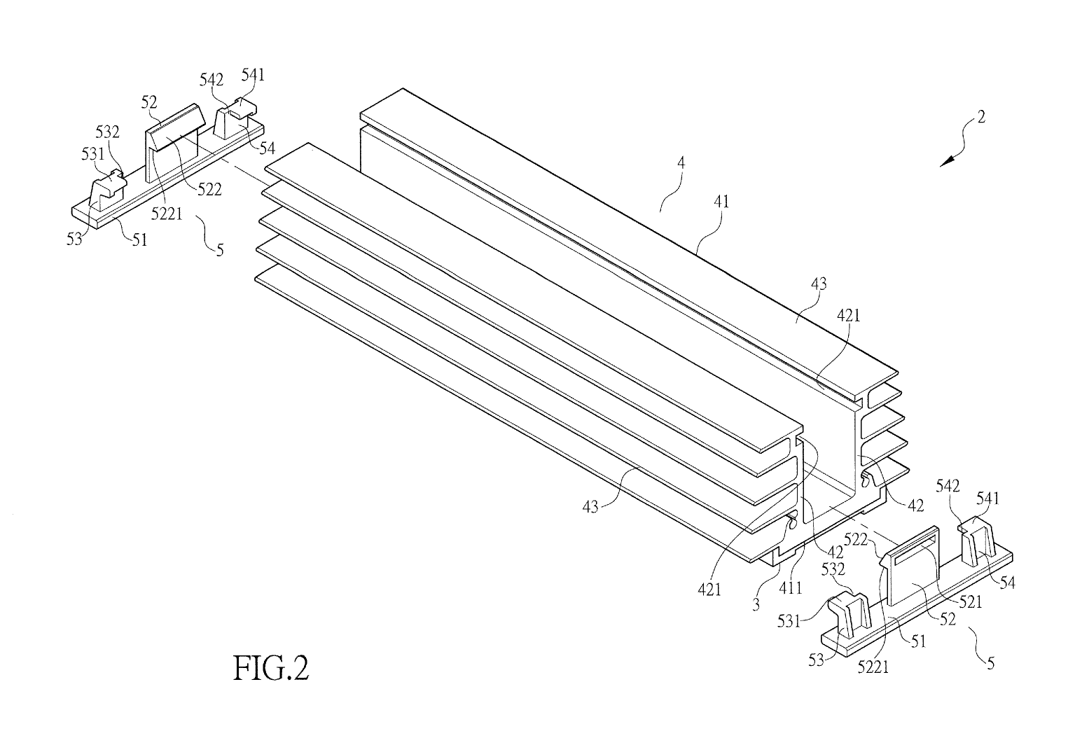

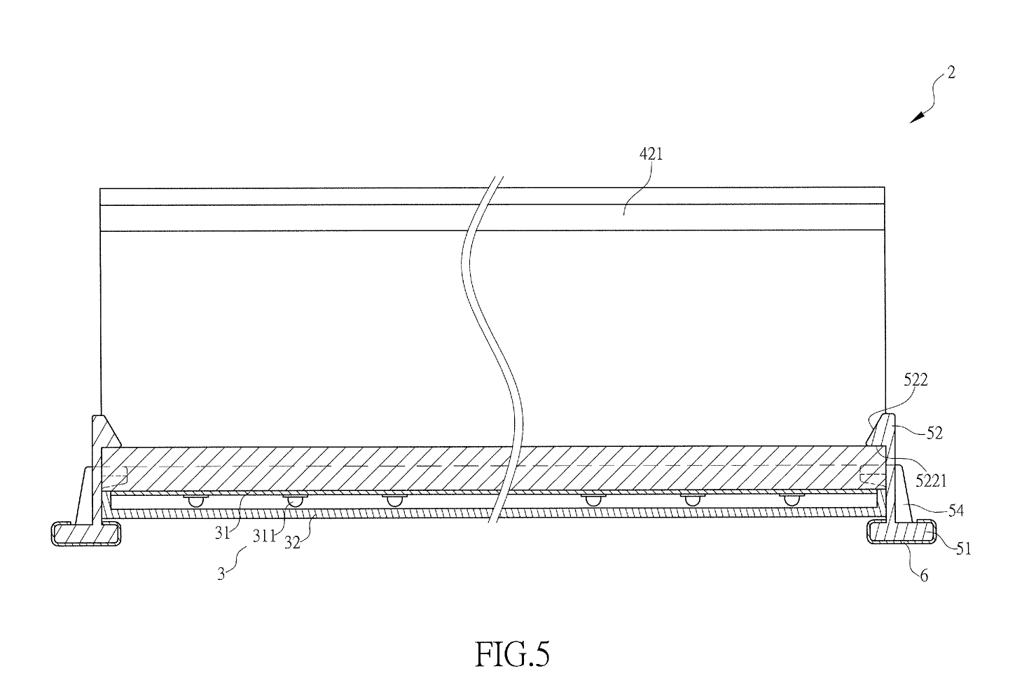

Referring to FIGS. 2 and 5, the present invention provides an LED (Light-Emitting Diode) lighting device 2, which comprises a light emission section 3, a heat dissipation section 4, and fasteners 5.

The light emission section 3 comprises a circuit board 31 and a cover 32. The circuit board 31 comprises a plurality of light-emitting diodes 311 mounted thereon. The circuit board 31 functions to apply electrical power to and actuate the light-emitting diodes 311 to give off light. The cover 32 is arranged to cover the circuit board 31 and house the light-emitting diodes 311.

The heat dissipation section 4 comprises a main body 41. The main body 41 has a bottom that forms a flat surface 411. The main body 41 has a top from which two ribs 42 extends upward to be substantially parallel to each other. Each of the two ribs 42 has an outer surface from which a plurality of heat dissipation fins 43 extends outward. Each of the two ribs 42 has an inner surface that is provided with a groove 421 that is formed by recessing an upper portion of the inner surface. The recessed grooves 421 of the ribs are arranged to be substantially opposing each other for receiving a fixing element (not shown) therein.

The fasteners 5 are respectively arranged at two opposite ends of the heat dissipation section 4. Each of the fasteners 5 has a flat plate like base 51. The base 51 comprises a retention section 52 and a first support section 53 and a second support section 54 extend upward therefrom. The first support section 53 and the second support section 54 are arranged at opposite sides of the retention section 52. The first support section 53 and the second support section 54 each have a top end forming a flat top surface 531, 541. The flat top surfaces 531, 541 of the first support section 53 and the second support section 54 each have a side that faces the retention section 52 and is cut off to form a notch 532, 542. The notches 532, 542 define therebetween a width that substantially corresponds to width of the light emission section 3. The retention section 52 comprises a horizontal slot 521 formed in a surface of an upper portion thereof. The horizontal slot 521 helps making the upper portion of the retention section 52 flexible. Further, the upper portion of the retention section 52 has an opposite surface on which a pawl 522 is formed and opposite to the horizontal slot 521. The pawl 522 of the retention section 52 has a bottom edge 5221, which shows a difference in altitude with respect to the flat top surfaces 531, 541 of the first support section 53 and the second support section 54. Specifically, a spacing distance is present between the bottom edge 5221 of the pawl 522 of the retention section 52 and the flat top surfaces 531, 541 of the first support section 53 and the second support section 54.

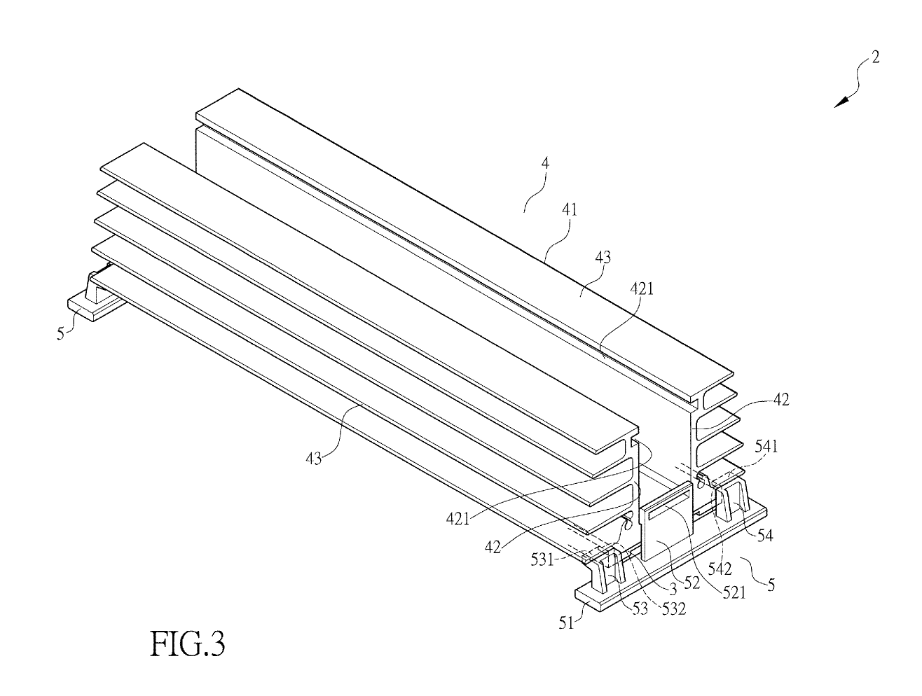

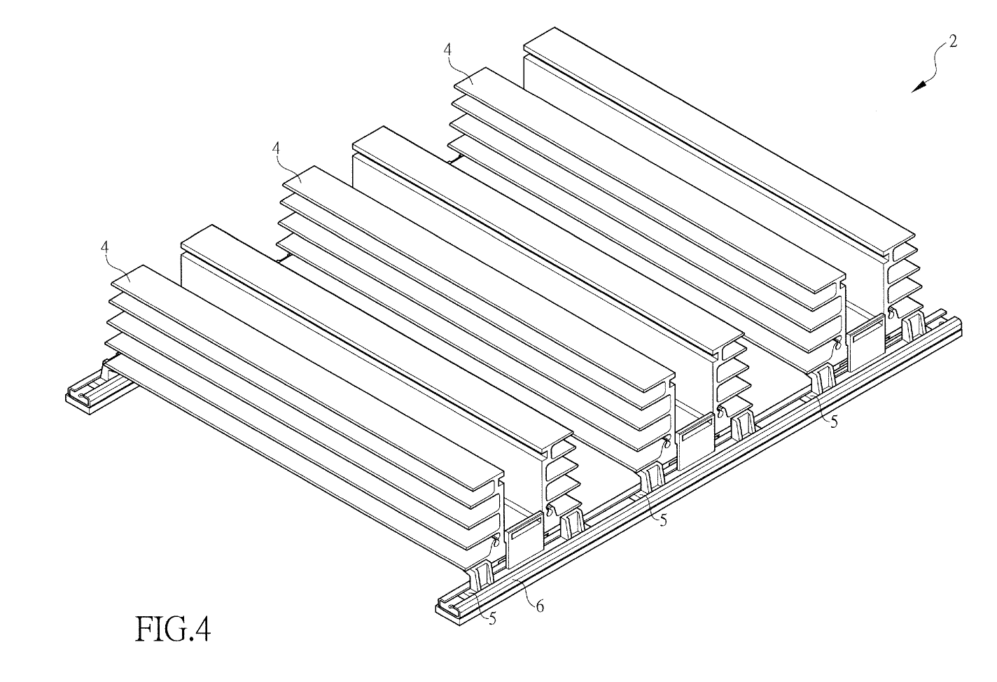

Referring to FIGS. 2, 3, 4, and 5, the LED lighting device 2 according to the present invention is constructed such that the fasteners 5 are respective set in retaining engagement with the opposite ends of LED lighting device 2. The flat top surfaces 531, 541 of the first support sections 53 and the second support sections 54 of the fasteners 5 receive the two bottommost heat dissipation fins 43 of the heat dissipation section 4 to be supported thereon, while the pawls 522 of the retention sections 52 of the fasteners 5 are set to catch the heat dissipation section 43. With the fasteners 5 engaging the heat dissipation section 4, the cover 32 of the light emission section 3 is received in and held between the notches 532, 542 of the flat top surface 531, 541 of the first support section 53 and the second support section 54 so that a secured engagement is established between the fasteners 5 and the heat dissipation section 4 and the light emission section 3. With the fasteners 5 in coupling engagement with the light emission section 3 and the heat dissipation section 4, the bases 51 of the fasteners 5 are receivable in positioning rails 6 (see FIG. 4) to thereby effect mounting and positioning of the LED lighting device 2 of the present invention.

The efficacy of the present invention is that two fasteners 5 are coupled to opposite ends of the LED lighting device 2 so that the LED lighting device 2 can be independently mounted to the positioning rails 6. When the LED lighting device 2 gets broken, it only needs to remove the specific one LED lighting device 2 alone from the fasteners 5 for replacement. There is no need to remove the completely set of lighting fixture as is generally done in the prior art. In this way, the operation of replacement and maintenance of the LED lighting device 2 is simplified.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fastener of LED lighting device, the LED lighting device comprising a light emission section and a heat dissipation section, the lighting device having opposite ends each provided with the fastener, the improvements comprising: the fastener comprising a base, the base comprising a retention section and a first support section and a second support section extending upward therefrom, the first support section and the second support section being arranged at opposite sides of the retention section, the first support section and the second support section each having a top end forming a flat top surface, the retention section comprising a pawl.

2. The fastener of LED lighting device according to claim 1, wherein the flat top surface of each of the first support section and the second support section has a side that faces the retention section and is cut off to form a notch.

3. The fastener of LED lighting device according to claim 2, wherein the notches define therebetween a width that substantially corresponds to width of the light emission section.

4. The fastener of LED lighting device according to claim 1, wherein the retention section has an upper portion in which a horizontal slot is formed.

5. The fastener of LED lighting device according to claim 1, wherein the pawl has a bottom edge that is spaced from the flat top surfaces of the first support section and the second support section by a distance.

6. The fastener of LED lighting device according to claim 1, wherein the flat top surfaces of the first support section and the second support section of the fastener are adapted to receive two bottommost heat dissipation fins of the heat dissipation section to be supported thereon.

7. The fastener of LED lighting device according to claim 1, wherein the pawls of the retention sections of the fasteners are set in retaining engagement with a main body of the heat dissipation section.
